(19) United States
(12) Patent Application Publication
(10) Pub. No.: US 2025/0177883 A1
(43) Pub. Date: Jun. 5, 2025

(54) METHOD FOR SOLID-PHASE EXTRACTION USING A POROUS MONOLITH

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR)

(72) Inventors: Laurent MUGHERLI, Gif-sur-Yvette (FR); Marc MALEVAL, Gif-sur-Yvette (FR); François FENAILLE, Gif-sur-Yvette (FR); Florent MALLOGGI, Gif-sur-Yvette (FR)

(73) Assignees: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR)

(21) Appl. No.: 18/842,270

(22) PCT Filed: Feb. 27, 2023
(86) PCT No.: PCT/EP2023/054787

§ 371 Date: Aug. 28, 2024

(30) Foreign Application Priority Data
Mar. 1, 2022 (FR) FR2201777

(51) Int. Cl. B01D 15/20; B01J 20/28; B01J 20/30; G01N 1/34; G01N 30/02

(52) U.S. Cl. CPC B01D 15/206; B01J 20/28042; B01J 20/28088; B01J 20/3064; G01N 1/34; G01N 30/02

(57) ABSTRACT

A method for solid-phase extraction and/or separation of one or more compounds of interest from a liquid sample which including: integrating a self-supporting porous monolith in a fluid duct wherein the self-supporting porous monolith is stationary in the fluid duct during the method and forms a filter in the fluid duct; passing the sample at least once through the porous monolith in the fluid duct over at least one portion of the porous monolith, the self-supporting porous monolith having a largest dimension less than or equal to 3 mm transverse to the fluid duct, the fluid duct having one or more open ends prior to integration, the or at least one of the ends remaining open during the step of integrating the porous monolith.

The present invention relates to a process for solid-phase extraction of one or more compounds of interest using a porous monolith incorporated in a fluidic conduit. The invention also relates to a process for incorporation of a porous monolith in a tube made of a heat-shrinkable material.

### TECHNICAL FIELD

The extraction of one or more compounds of interest from a complex mixture is essential for subsequent use, in particular to make possible their identification and/or their quantification. The quality of the extraction of the compound(s) of interest greatly influences the quality of the results obtained subsequently.

There currently exist several methods for extracting compounds of interest.

A practical and efficient means of carrying out an extraction consists in causing a solution containing the molecules of interest to move through a solid phase. For this, it is necessary to have a fluidic circuit incorporating a porous material with a cross section perfectly suited to the conduit in which it is incorporated and fixed in order to guarantee that the solution moving in the circuit unavoidably passes through the porous material.

Among the materials which can be used as solid phase for the extraction, porous monoliths, in particular those having a hierarchical porosity (HPM), exhibit advantages such as a good permeability, a porosity and a surface chemistry which is adjustable. The production of devices for the extraction of a miniaturized format is a challenge.

As is described in the papers by Nema et al., Talanta, 82 (2010), 488-494 Application of Silica-Based Monolith as Solid Phase Extraction Cartridge for Extracting Polar Compounds from Urine, Ma, X., Zhao, M., Zhao, F. et al., Application of Silica-Based Monolith as Solid-Phase Extraction Sorbent for Extracting Toxaphene Congeners in Soil, J. Sol-Gel Sci. Technol., 80, 87-95 (2016), and Jorge C. Masini et al., Porous Monolithic Materials for Extraction and Preconcentration of Pollutants from Environmental Waters, Trends in Environmental Analytical Chemistry, Volume 29, 2021, e00112, ISSN 2214-1588, one method for incorporating an HPM in a fluidic circuit consists in embedding it into the body of a syringe, in particular by forcible insertion. This can only be achieved for HPMs exhibiting sufficient resistance to manual embedding stresses, in particular exhibiting a width of several millimeters.

As is described in the application JP2003166983, another method for encapsulating an HPM for the purpose of an SPE or chromatography use consists in using a heat-shrinkable tube which, when it is heated at 100° C. for 10 minutes, retracts onto the HPM to encapsulate it and to hold it in position. This method is commonly used to encapsulate porous monoliths having a width of several mm. However, for porous monoliths having a small diameter, in particular having a diameter of less than or equal to 2 mm, it is established, in particular in the patent U.S. Pat. No. 7,291,383, that the encapsulation as described in the abovementioned Japanese patent application does not make it possible to retain both the integrity of the HPM and the leaktightness of the incorporation.

Such extraction devices with HPMs having large widths require moving several times several hundred microliters over the HPM. They function with flow rates obtained by the creation of an air vacuum at the outlet of the device or else by centrifugation. They are thus not very flexible and are difficult to control precisely. Moreover, they are not always compatible with the constraints of certain fields, in particular the “-omics” fields, including proteomics, metabolomics or glycomics, in terms of reduced amount of the samples, of small volume of the samples to be analyzed and of speed required.

A solution proposed for miniaturizing such systems, in particular by the patent U.S. Pat. No. 7,291,383 and the paper by Jorge C. Masini et al., Porous Monolithic Materials for Extraction and Preconcentration of Pollutants from Environmental Waters, Trends in Environmental Analytical Chemistry, Volume 29, 2021, e00112, ISSN 2214-1588, is to form in situ the HPM in a capillary with an internal diameter of less than 1 mm. In the capillaries obtained, porosity gradients exist, as shown in particular in the paper by Bruns, S., Müllner, T., Kollmann, M., Schachtner, J., Höltzel, A. and Tallarek, U. (2010), Confocal Laser Scanning Microscopy Method for Quantitative Characterization of Silica Monolith Morphology, Analytical Chemistry, 82 (15), 6569-6575, which harms the reproducibility, and scanning electron microscopy images show, on the one hand, very often that the anchoring of the HPMs in the capillaries is incomplete, freeing interstitial spaces which can harm the reproducibility, indeed even the quality, of the extraction by creating preferential paths and, on the other hand, that, for one and the same formulation, the structure is not similar when the diameter of the capillary varies, which implies that major modifications be made to the initial compositions but also to the stages of the process compared to what is done for the larger self-supporting monoliths in order to limit in particular the edge effects at the wall of the capillary, which makes the preparation of such capillaries lengthy and complex and results in structural variations.

The international application WO 2005/072164 describes a monolith incorporated in a polyethylene tube by insertion of the monolith into the tube, then the assembly is heated until the tube is in a molten state and comes to encapsulate the monolith, and finally the ends are cut in order to make possible the movement of the fluid in the porous monolith. The international application WO 2008/112702 describes a system comprising a porous monolith incorporated in a support by heating the support in order to shrink it onto the porous substrate. This document more particularly describes a porous monolith with a diameter of 1.2 mm inserted into a borosilicate glass tube having an internal diameter of 1.8 mm and the heating of the assembly at a temperature of 850° C. in order to melt the glass and to shrink it onto the monolith, then the cutting of the assembly in order to obtain parts which can be used in chromatography. Placing the tubes in a molten state means the molten material will penetrate into the pores of the porous monolith over the entire surface of the latter. It is thus necessary to again cut the assembly to make possible access to the porous part of the monolith. Such cutting makes the use of the assembly more complex, in particular in terms of connection, and can damage the porous monolith, in particular in the case of a monolith of small diameter. Moreover, the penetration of the material of the tube into the pores of the monolith makes the use of a monolith of small diameter complicated at the risk of filling all the pores of the monolith during the melting of the material of the tube and of thus clogging the porous monolith.

There thus exists a need to have available a process for extraction of compounds of interest from samples of reduced volumes which is simultaneously simple, rapid, efficient and reproducible.

### SUMMARY OF THE INVENTION

The invention meets this need by means of a process for solid-phase extraction of one or more compounds of interest from a liquid sample, comprising:
the incorporation of a self-supporting porous monolith in a fluidic conduit so that the self-supporting porous monolith is fixed in the fluidic system during said process and forms a filter in the fluidic system,
at least one passage of the sample through the porous monolith in the fluidic conduit over at least a portion of the porous monolith, the self-supporting porous monolith having a greatest dimension transverse to the conduit of less than or equal to 3 mm.

The term “forms a filter” is understood to mean that any liquid traversing the fluidic conduit passes through the porous monolith over at least a part of its length, in particular over its entire length, the length being defined as the greatest dimension along the axis of the fluidic conduit. The fact that the porous monolith has a dimension of less than or equal to 3 mm makes it possible to be able to treat samples of very small volumes, which is particularly advantageous in certain fields, but also makes it possible to have a rapid and robust treatment. This also makes it possible to optimize the subsequent analysis of the extracted compounds of interest by reducing the need for preconcentration of these compounds before their analysis.

The use of a porous monolith makes it possible to have a device having a very good extraction efficiency and which is versatile. This is because it is easy to adapt the porosity characteristics and the surface chemistry of the porous monolith to the desired type of extraction.

### Process for Formation of the Monolith

Preferably, the porous monolith is formed by a sol-gel process. The term “sol-gel process” is understood to mean a process carried out by using, as precursors, alkoxides of formula M(OR)ₙ, R′-M (OR)ₙ₋₁ or also sodium silicates or titanium colloids, M being a metal, a transition metal or a metalloid, in particular silicon, and R or R′ being alkyl groups, n being the degree of oxidation of the metal. In the presence of water, hydrolysis of the alkoxy (OR) groups takes place, forming small particles generally of less than 1 nanometer in size. These particles aggregate and form clusters which remain in suspension without precipitating, and form the sol. The increase in the clusters and their condensation increases the viscosity of the medium and forms what is called the gel. The gel can then continue to evolve during an aging phase during which the polymer network present within the gel becomes denser. The gel subsequently shrinks by discharging the solvent outside the polymer network formed, during a stage called syneresis. The solvent then evaporates, during a “drying” stage, which leads to a solid material of porous glass type giving a porous monolith. The syneresis and drying stages can be concomitant.

Preferably, the self-supporting porous monolith is formed by a manufacturing process comprising:
the formation of a sol comprising a sol-gel precursor in aqueous solution and, preferably, a pore-forming agent,
the at least partial filling of a chamber and of at least one mold contained in the chamber with sol formed previously, the mold comprising at least one opening which opens into the sol after filling with sol,
the formation of a sol-gel matrix in the chamber starting from the sol,
the extraction of the mold with the sol-gel matrix contained in the mold from the chamber, and
the extraction of the sol-gel matrix from the mold,
the formation of a porous monolith starting from the sol-gel matrix extracted from the mold,
   the formation of the sol, of the sol-gel matrix and of the porous monolith taking place by a sol-gel process.

The presence of at least one opening in the mold below the sol level after filling makes possible the filling of the mold by the sol during the filling stage and the fluidic movement of the sol between the sol contained in the mold and the sol contained in the chamber during the continuation of the process. The fact of producing a large sol-gel matrix in the chamber and of extracting therefrom a part included in a mold during the formation of the matrix makes it possible to overcome the edge effects which appear in the processes described above by producing the sol-gel matrix in a receptacle which is always of the same size. Such a process makes it possible to manufacture self-supporting porous monoliths with similar textural properties over a wide range of diameters without having to reoptimize, indeed even modify, the formulation of the initial mixture. It also makes possible access to a great variety of shapes and aspect ratios of the monoliths, but also to controlled, varied and reproducible internal structures. The structures obtained are particularly uniform and thus guarantee homogeneity of resistance to mechanical stresses. This can prove to be useful, for example in preventing breakages when pressure is exerted on the monolith during its incorporation in the fluidic conduit, in particular during its encapsulation in a heat-shrinkable fluidic conduit.

The sol can be formed by stirring a solution comprising the sol-gel precursor, preferably the sol-gel precursor and the pore-forming agent, in particular for a period of time of greater than or equal to 5 min, better still of greater than or equal to 10 min, even better still of greater than or equal to 15 min. The duration of the stirring can be less than or equal to 3 h, better still less than or equal to 2 h. During the stirring, the temperature can be controlled at a substantially constant predetermined value, in particular of between 0° C. and 90° C., better still between 0° C. and 50° C.

The filling can be carried out without the presence of air bubbles and/or of gradients of chemical composition and/or of temperature of the sol in the chamber and the mold(s).

The formation of the sol-gel matrix can comprise condensation, to form a gel, and optionally at least partial aging, to densify the gel.

Preferably, the formation of the sol-gel matrix in the chamber is devoid of drying of the sol-gel matrix.

The formation of the sol-gel matrix can be carried out in the same way in the chamber and the mold. The total porosity and the size of the pores are preferentially substantially homogeneous in the chamber and the mold(s).

The extraction of the mold with the matrix which it contains from the chamber can comprise an extraction of a block of the sol-gel matrix containing the mold from the chamber and the extraction of the mold and of the sol-gel matrix which it contains from the previously extracted block. The extraction of the or of each mold from the block can be carried out by cutting the sol-gel matrix flush with the corresponding mold or breaking the sol-gel matrix surrounding the mold(s). Alternatively, the extraction of the or of each mold with the matrix which it contains can be carried out by removing, from the corresponding mold, the sol-gel matrix surrounding it after extraction of the block as described above or directly in the chamber without prior extraction of the block, in particular when the corresponding mold is only partially immersed in the sol-gel matrix.

The extraction of the sol-gel matrix contained in the or each mold can be carried out by means of a controlled pressure on said sol-gel matrix, for example by direct pressure with a solid smaller in dimension than the mold or by pressure of a gas at a controlled flow rate or by opening the or each mold, in particular by cutting the or each mold or separation of two parts of the or of each mold from one another. The mold(s) can be in the form of two parts that are movable together, in particular separable or movable with respect to each other by a hinge.

The mold containing the sol-gel matrix can be immersed in a liquid during the stage of extraction of the sol-gel matrix contained in the mold. This facilitates the extraction of the sol-gel matrix.

The process for the manufacture of the porous monolith can comprise a controlled generation of mesoporosity in the sol-gel matrix in order to form a sol-gel matrix having a hierarchical porosity after the extraction of the mold from the chamber and before the formation of the porous monolith starting from the sol-gel matrix of the mold. The controlled generation of mesoporosity can be carried out by immersion of the sol-gel matrix, extracted or not from the or from each mold, in an aqueous solution for generation of the mesoporosity comprising an agent for dissolution of the sol-gel matrix and/or a precursor of agent for dissolution of the sol-gel matrix. The dissolution agent can be ammonium hydroxide, for example at a concentration of 1M, sodium hydroxide, or hydrofluoric acid or their mixtures. The precursor of agent for dissolution of the sol-gel matrix can be urea or compounds carrying amide functions, in particular formamide, acetamide, N-methylformamide (NMF) and their mixtures. Preferably, the concentration of dissolution agent and/or of dissolution agent precursor is such that it makes possible the localized dissolution of the sol-gel matrix or matrices so as to form mesopores in this or these without dissolving the sol-gel matrix or matrices overall.

The formation of the porous monolith can comprise at least partial aging in order to densify the sol-gel matrix, in particular when aging did not take place completely before.

The formation of the porous monolith can comprise a drying of the sol-gel matrix extracted or not from the mold in order to form a dried sol-gel matrix, after the generation of the mesopores, if appropriate. The drying stage can be carried out under a stream of air or inert gas, in particular molecular nitrogen, argon or carbon dioxide, helium, indeed even molecular oxygen or molecular hydrogen.

The formation of the porous monolith can comprise a heat treatment of the sol-gel matrix or matrices extracted or not from the or from each mold, in particular after the drying. The heat treatment can be carried out in a closed container under a flow of air or inert gas, in particular molecular nitrogen, argon or carbon dioxide, helium, indeed even molecular oxygen or molecular hydrogen, and by gradual heating, followed by the maintenance of the final temperature for a predetermined time. The gradual heating can be an increase of 0.5° C./min until reaching a temperature of greater than or equal to 300° C., better still of greater than or equal to 340° C., for example substantially equal to 350° C., in order to obtain a porous monolith. The final temperature can be maintained for more than 1 h. This makes it possible to stabilize the structure of the monolith and to remove the organic residues resulting from the synthesis.

In an alternative form, the porous monolith is formed directly in a mold into which the sol is inserted and is extracted therefrom, in particular by the abovementioned method.

### Porous Monolith

The porous monolith can comprise macropores, in particular macropores with a dimension of greater than or equal to 50 nm. The macropores can exhibit a dimension of less than or equal to 30 μm. The porous monolith can comprise mesopores, in particular with a dimension of less than or equal to 50 nm, better still of between 2 and 50 nm. Preferably, the pores are interconnected in the porous monolith. This makes it possible to obtain porous monoliths having a hierarchical porosity, that is to say exhibiting at least two orders of magnitude of sizes of pores, preferably macropores formed during the formation of the sol-gel matrix and mesopores formed during the controlled generation of mesopores. Such porous monoliths exhibit a good surface area for exchange between the solution traversing it and its material and minimize the distances to be travelled by diffusion. Furthermore, this makes it possible to introduce a flexibility to the sol-gel matrix while reducing the risks of breakage. Furthermore, this makes it possible to reduce the drying time of the sol-gel matrix.

The porous monolith can exhibit a greatest dimension transverse to the conduit of less than or equal to 2 mm, better still of less than or equal to 1.5 mm, even better still of less than or equal to 1 mm.

The self-supporting porous monolith can exhibit a greatest dimension transverse to the conduit of greater than or equal to 20 μm.

Preferably, the porous monolith can exhibit a length of greater than or equal to 0.5 mm, better still of greater than or equal to 1 mm, even better still of greater than or equal to 2 mm.

Preferably, the porous monolith can exhibit a length, taken along the longitudinal axis of the conduit, which is greater than its greatest transverse dimension.

Preferably, the porous monolith is incorporated in the conduit and configured so that any liquid traversing the fluidic conduit traverses the porous monolith over a distance of at least 10% of its length, better still of at least 50%, even better still the entire length.

Preferably, the porous monolith is cylindrical with a diameter of less than or equal to 1.5 mm, better still of less than or equal to 1 mm, and with a length of greater than or equal to 0.5 mm, better still of greater than or equal to 1 mm, even better still of greater than or equal to 2 mm.

The porous monolith can be of substantially homogeneous structure throughout its volume.

The porous monolith can exhibit an aspect ratio, defined as the ratio of its height to its greatest transverse dimension, of greater than or equal to 0.2, better still of greater than or equal to 0.4, better still of greater than or equal to 1 and/or of less than or equal to 1000, better still of less than or equal to 500, even better still of less than or equal to 100, better still of less than or equal to 50, even better still of less than or equal to 20.

Preferably, the porous monolith is cylindrical with a polygonal, oval or circular base, in particular cylindrical in revolution.

The process can comprise modifications to the porous monolith after manufacture, in particular the functionalization of the surface of the porous monolith, in particular before or after its incorporation in the conduit. The surface of the porous monolith can be covered with molecules, such as hydrophobic hydrocarbon ligands (for example octadecyl ligands) or such as hydrophilic ligands, such as 2,3-dihydroxypropyl derivatives. The ligands of such modified columns can be further modified using known procedures. Porous catalysts or enzyme supports can be prepared by adding enzymes, for example glucose isomerase or peptide-N-glycosidase F (PNGase F), or catalytic metal elements, for example platinum and palladium.

### Fluidic Conduit

Preferably, the fluidic conduit exhibits at least one open end, better still two open ends.

Preferably, the fluidic conduit is traversing. The fluidic conduit is preferably open on either side of the porous monolith.

In an alternative form, the fluidic conduit is closed at its end downstream of the porous monolith so as to form a well. In this case, the porous monolith can be at the closed end of the conduit or the fluidic conduit can comprise a space between its closed end and the porous monolith. The sample can then traverse the porous monolith from side to side during its passage through the porous monolith, in particular when a space is present downstream of the latter, or traverse it over a part of its height according to a round trip, in particular in the case where the porous monolith is at the closed end of the conduit.

Preferably, the fluidic conduit is monolayer.

The fluidic conduit can be made of a heat-shrinkable polymer, in particular of polyolefin, such as polyethylene (PE) or polyvinyl chloride (PVC), of polytetrafluoroethylene (PTFE), of fluorinated ethylene-propylene (FEP), of polyetheretherketone (PEEK) or of polyvinylidene fluoride (PVDF), or their mixture.

The fluidic conduit can exhibit a constant wall thickness of greater than or equal to 0.004 mm, better still of greater than or equal to 0.15 mm, or even better still 0.2 mm. Preferably, the thickness of the wall of the conduit is less than or equal to 1 mm, better still less than or equal to 0.9 mm, even better still less than or equal to 0.65 mm.

The fluidic conduit can be rigid, flexible or preferably semi-rigid.

The fluidic conduit may have an elastic wall.

The fluidic conduit can be transparent. This makes possible direct visualization of the passage of the solution, in particular when the latter is colored, which makes it possible to monitor the process.

In an alternative form, the conduit can be completely or at least partially opaque. The conduit can comprise a transparent viewing window at the porous monolith.

Preferably, the fluidic conduit is configured to exhibit, after incorporation of the porous monolith, a minimum diameter of less than or equal to, better still strictly of less than, the greatest transverse dimension of the porous monolith, preferably the smallest transverse dimension of the porous monolith, in particular its diameter, the transverse dimension being understood along a transverse plane of the conduit after incorporation of the monolith in the conduit. The fluidic conduit can comprise a minimum diameter strictly of less than 100%, better still of less than or equal to 98%, even better still of less than or equal to 95%, of the smallest transverse dimension of the porous monolith, in particular of its diameter. The minimum diameter of the conduit can be greater than or equal to 50%, better still 60%, better still 70%, better still 80%, of the smallest transverse dimension of the porous monolith.

The fluidic conduit can exhibit a shrinkage coefficient, defined as the ratio of the initial diameter to the minimum diameter attainable after shrinking, of greater than or equal to 1.5:1, better still of greater than or equal to 2:1. Preferably, the shrinkage coefficient is less than or equal to 6:1.

The fluidic conduit can be configured to shrink at a temperature of greater than or equal to 70° C., better still of greater than or equal to 100° C.

In an alternative form, the fluidic conduit can be a pipette tip or a solid-phase extraction cartridge. In this case, the porous monolith can be forcibly inserted into the fluidic conduit. The fluidic conduit can comprise an inner wall exhibiting a leaktightness layer which comes into contact with the outer wall of the porous monolith. Such a layer can be made of an adhesive layer or a layer made of an elastic material. The fluidic conduit can exhibit an internal diameter which is less than or equal to that of the porous monolith. In this case, the fluidic conduit and the porous monolith can be of complementary conical shape. Preferably, at least a portion of the conduit with a length greater than or equal to the length of the porous monolith, better still the whole conduit, is in the form of a cylindrical tube, in particular having a circular base. In an alternative form, at least a portion of the conduit with a length greater than or equal to the length of the porous monolith, better still the whole conduit, is of truncated conical shape. The term “length of the porous monolith” is understood to mean its greatest dimension along the longitudinal axis of the conduit after incorporation. Preferably, the porous monolith has an external surface of the same shape as said portion of the conduit, except for the dimensions, if appropriate.

Preferably, the fluidic conduit exhibits, after incorporation of the porous monolith, a fluidic movement length strictly greater than the length of the porous monolith. Preferably, the fluidic conduit exhibits, at its or one of its open ends, after incorporation of the porous monolith, a non-zero length of conduit devoid of porous monolith. This makes it possible to facilitate the introduction of the sample into the tube upstream of the porous monolith by facilitating the incorporation of the assembly into the extraction device by the ease of fluidic connection of the extended end. In addition, the length of fluidic movement can be adapted depending on the specific fluidic protocol of a particular usage case.

Preferably, the porous monolith is incorporated in the fluidic conduit without protruding from the fluidic conduit. This makes it possible to facilitate the incorporation of the fluidic conduit in a fluidic device and facilitates the passage of the liquid sample through the fluidic conduit. This also makes it possible to have a supply of liquid in the fluidic conduit, in particular upstream of the porous monolith, which can make it possible to prepare beforehand an amount of a solution or a sequence of several solutions in predetermined quantities in the fluidic conduit upstream of the porous monolith to be passed through the porous monolith.

### Incorporation Stage

Preferably, the fluidic conduit exhibits one or more open ends before incorporation of the porous monolith and the or at least one of the open ends of the fluidic conduit before incorporation remain(s) open during the incorporation of the porous monolith. This makes possible the passage of the sample through the porous monolith without it being necessary to open an end of the conduit after incorporation of the porous monolith.

Preferably, the porous monolith retains its integrity during the stage of incorporation in the fluidic conduit. In particular, the incorporation of the porous monolith in the fluidic conduit is carried out so that it is not necessary to cut a part of the porous monolith, in particular one of its ends, to make possible the passage of the sample within it. This makes it possible to limit the risk of degradation of the porous monolith by limiting the actions on the latter and facilitates the incorporation of the assembly of the fluidic conduit incorporating the porous monolith in a device for movement of the sample. In particular, during the incorporation stage, the fluidic conduit is not melted in order to encapsulate the porous monolith. Such an incorporation would generate a local penetration of the material of the fluidic conduit at the surface of the porous monolith, which would require, to make possible the passage of the sample, cutting, at least at one end of the porous monolith, the porous monolith over the penetration thickness, which might damage the porous monolith, in particular when it is small in diameter.

Preferably, the incorporation of the porous monolith is carried out without it being necessary to amputate the fluidic conduit of a part of its length to make possible the passage of the sample through the porous monolith. The resulting device makes it possible to limit the stages necessary before the passage of one or more solutions, in particular of the sample, through the fluidic conduit.

Preferably, the fluidic conduit is made of a heat-shrinkable polymer and the incorporation of the porous monolith in the fluidic conduit can comprise the insertion of the porous monolith into the fluidic conduit and the heating of the fluidic conduit in order to shrink the conduit so as to encapsulate the porous monolith in said conduit.

Preferably, the heating of the conduit is carried out at a temperature which is greater than or equal to the minimum shrinkage temperature of the conduit, in particular at a temperature of greater than or equal to 70° C., better still of greater than or equal to 100° C., even better still of greater than or equal to 300° C. Preferably, the heating of the conduit is carried out at a temperature which is less than or equal to the melting or degradation temperature of the fluidic conduit, in particular less than or equal to 800° C., preferably less than or equal to 700° C., better still less than or equal to 500° C.

Preferably, the shrinkage of the conduit is such that, after shrinkage, the inner wall of the conduit extends along the covering surface of the porous monolith without melting into the surface pores of the porous monolith.

Preferably, the shrinkage of the conduit is such that the porous monolith remains fixed in the conduit when a solution is introduced into the tube at a pressure of between 0.05 and 7 bar, preferentially between 0.1 and 5 bar, even better still between 0.15 and 4 bar.

Preferably, the heating of the conduit is carried out by heating the conduit for a period of time and at a temperature chosen so that the fluidic conduit shrinks until it comes into contact with the outer wall of the porous monolith over at least a part of the length of the porous monolith, better still over the entire length of the porous monolith, in particular until it matches the shape of the covering surface of the porous monolith. Preferably, after heating, the portions of the conduit directly upstream and downstream of the porous monolith exhibit respective diameters strictly of less than 100%, better still of less than or equal to 95%, better still 90%, of the smallest transverse dimension of the directly adjacent end section of the porous monolith.

The heating of the conduit can be carried out using a heating gun moved manually along the conduit. Preferably, the heating gun is moved along the conduit in a substantially regular manner so as not to heat a conduit portion for more than 10 min, better still more than 2 min, even better still more than 1 min. The heating gun can be adjusted to emit at the outlet a temperature of more than 450° C. during the heating of the conduit and be positioned at less than 15 cm, better still less than 4 cm, even better still 2 cm, from the conduit during the heating.

In an alternative form, the heating is carried out in an oven. In this case, the temperature of the oven is at least 70° C., better still greater than or equal to 150° C., even better still greater than or equal to 300° C., preferably less than or equal to 800° C., better still less than or equal to 700° C., even better still less than or equal to 500° C. Preferably, it is chosen between the minimum shrinkage temperature and the melting or degradation temperature of the fluidic conduit. The heating can be maintained for a period of time dependent on the temperature so that the heat-shrinkable polymer of the fluidic conduit does not degrade, in particular of less than or equal to 1 h for a temperature of between 300° C. and 450° C. and of less than or equal to 30 min, better still 15 min, for a temperature of between 450° C. and 650° C.

Preferably, the assembly of the conduit and of the porous monolith after incorporation is characterized in that it is devoid of a continuous fluidic path extending between the inner wall of the conduit and the porous monolith connecting conduit portions over lengths at least 20 times greater than the mean size of the macropores, better still over lengths at least 10 times greater than the mean size of the macropores.

In an alternative form, the heating stage can be carried out by a predetermined variable temperature profile. The predetermined temperature profile can comprise temperature stationary phases and/or a gradient of gradual increase in the temperature.

The process can comprise the incorporation of a plurality of porous monoliths in a plurality of unconnected conduits and the passage of a plurality of samples, each through a porous monolith in one of the conduits.

The porous monolith can be incorporated so that, during the passage of the sample through the fluidic conduit, every fraction of the sample moves through the porous monolith over at least a portion of the length of the latter.

After incorporation of the porous monolith in the fluidic conduit, the fluidic conduit can be incorporated in a fluidic device configured to introduce a solution, in particular the sample, into the conduit and to move it through the conduit.

The fluidic device can comprise a solution feed member configured to be connected to an end of the fluidic conduit. The liquid feed member can be configured to be connected at its other end to a liquid reservoir which can be interchanged according to the solution to be introduced into the conduit, in particular to a reservoir containing the sample.

The fluidic device can comprise a pressure controller or a syringe driver connected to the fluidic conduit upstream or downstream of the porous monolith, in particular via the liquid feed member for the conduit, configured to control the movement of the fluid through the conduit.

In an alternative form, the device may comprise a centrifugation device for causing a solution, in particular the sample, to pass by centrifugal force through the porous monolith, in particular when the conduit exhibits a closed end.

The conduit can be open at both its ends and the fluidic device can comprise a member for distribution of the liquid at the outlet of the fluidic conduit. The member for distribution of the liquid can be a needle. Such a member for distribution of the liquid can make it possible to facilitate the accuracy of recovery of the liquid at the conduit outlet and the accuracy of distribution on or in one or more withdrawal members. In an alternative form, the solution at the outlet of the conduit is directly recovered without passing through an additional distribution member at the outlet of the conduit.

### Sample

Preferably, the sample which passes through the porous monolith is less than 500 μl, better still less than 250 μl, even better still less than 100 μl.

The sample can be formed from a withdrawn sample of blood, in particular plasma or serum, cerebrospinal fluid, urine or milk, in particular human milk. Preferably, such a withdrawn sample is modified before its passage through the porous monolith.

### Solid-Phase Extraction

The process can be a process of solid-phase extraction of compounds of interest by adsorption of the latter on the surfaces of porous monoliths in order to separate them from the remainder of the sample, then recovery by elution of the compounds of interest adsorbed on the surfaces of the porous monolith. The process preferentially comprises, before the passage of the sample, the conditioning of the porous monolith by passage of one or more successive conditioning solutions in the fluidic conduit through the porous monolith. Such a conditioning makes it possible to impregnate the porous monolith with solvent in order to improve the adsorption of the compounds of interest. The conditioning of the porous monolith in the conduit can comprise the passage of a polar solvent, in particular comprising water and/or acetonitrile. Preferably, the polar conditioning solvent is identical to the solvent of the sample. The conditioning can comprise the passage of a first solution of water, in particular pure water, in the conduit through the porous monolith and the passage of an aqueous acetonitrile solution, in particular at 80% by volume.

The process can comprise, after the passage of the sample through the porous monolith, the washing of the porous monolith by passage of one or more washing solutions in the fluidic conduit through the porous monolith. The washing solution can be of lower polarity than the solvent of the sample. The washing solution can be an aqueous solution of acetonitrile at more than 50% by volume, better still 70%. Such a washing makes it possible to remove impurities from the porous monolith without eluting the compounds of interest in order to improve the purity of the analytes.

The process can comprise, after the passage of the sample and, if appropriate, after the washing, the elution of the compounds of interest by passage of an eluting solution or of several fractions of eluting solution through the porous monolith in the fluidic conduit and the recovery of the eluate(s) for the purpose in particular of their analysis in order to determine the composition thereof of compounds of interest. Elution can be carried out by passage of several successive fractions, unconnected or not, of eluting solution through the porous monolith and by recovery of each eluate after passage thereof through the porous monolith in dissociated recovery systems. The or each fraction of eluting solution can exhibit a volume of less than or equal to 10 μl, better still of less than or equal to 5 μl, even better still of less than or equal to 1 μl. The recovery of the eluates can be carried out on different areas of a plate, in particular of a mass spectrometer plate using a matrix-assisted laser desorption/ionization (MALDI) source coupled or not to a time-of-flight analyzer (MALDI-TOF).

The process can comprise the analysis of the eluate(s). The eluting solution can be of higher polarity than the solvent of the sample, in particular be pure water.

The analysis can be carried out by mass spectrometry, in particular a mass spectrometer coupling a matrix-assisted laser desorption/ionization (MALDI) source and a time-of-flight (TOF) analyzer, by liquid chromatography coupled to detection by fluorescence (LC-Fluo) or by capillary electrophoresis coupled to fluorescence (CE-LIF). The analysis is preferably carried out after recovery of the eluting solution, optionally after addition of a matrix substance suited to the analytical process, in particular to MALDI-TOF, in particular a solution comprising 2,5-dihydroxybenzoic acid in methanol at 50% by volume, without a prior stage of drying the eluting solution.

Preferably, the extraction process is carried out in the absence of acid, in particular of formic or trifluoroacetic acid. In an alternative form, an acid, in particular a proportion of greater than or equal to 0.1% by volume of an acid, in particular of formic or trifluoroacetic acid, is added to the conditioning solution, the washing solution and/or the eluting solution.

A base can be added to the conditioning solution, the washing solution and/or the eluting solution.

Preferably, the extraction process comprises a prior stage of preparation, in the fluidic conduit upstream of the porous monolith, of a sequence of the various successive solutions which have to pass through the porous monolith to make possible extraction, in particular of the conditioning solution, of the sample, of the washing solution and of the eluting solution, in the form of one or more successive fractions. This makes possible precise control of the extraction by the simple control of the pressure in the fluidic conduit. This also makes it possible to have precise control of the volumes of the various solutions and of the times between the different stages.

The process can comprise a single passage of the sample and/or of the (various) solution(s) through the porous monolith. In this case, the sample and/or the solution(s) preferentially traverse the porous monolith over its entire length. The conduit is then preferentially open on either side of the porous monolith or exhibits a free space downstream of the porous monolith.

In an alternative form, the process can comprise the passage of the sample and/or of the (various) solution(s) through the porous monolith more than once over a part of its length or over its entire length. The sample and/or (various) solution(s) can thus make one or more round trips through a portion or the whole of the porous monolith. This is in particular the case when the porous monolith is at the bottom of a closed conduit.

Preferably, the passage of the sample and/or of the (various) solution(s) through the porous monolith is driven in particular by control of the pressure in the fluidic conduit or by any other means, in particular by the application of a centrifugal force. In an alternative form, the passage of the sample and/or of the (various) solution(s) through the porous monolith can be carried out by gravity.

In particular in the case of a porous monolith incorporated at the bottom of a fluidic conduit closed at one of its ends, the process can comprise the agitation of the fluidic conduit in order to make possible the movement of the solution and/or of the sample present in the porous monolith at each of the abovementioned stages of passage of a solution through the porous monolith.

The process can be a process of extraction of the free N-glycans or oligosaccharides in a biological sample.

Preferably, the sample which passes through the porous monolith comprises free N-glycans or oligosaccharides and the porous monolith is configured to adsorb these entities contained in the sample during the passage of the latter through the porous monolith.

The process can comprise the preparation of the sample prior to the extraction, in particular to release the N-glycans or the oligosaccharides in the sample. In the case of the extraction of the N-glycans, the sample can be prepared prior to the extraction according to the method described in the paper by Sophie Cholet et al., N-Glycomics and N-Glycoproteomics of Human Cerebrospinal Fluid, Current Proteomic Approaches Applied to Brain Function, 127, Humana Press, 360 p., 2017, Neuromethods, 978-1-4939-7119-0 978-1-4939-7118-3. The preparation of the sample can comprise the following stages, in particular as described in the abovementioned paper:
the release of N-glycans by denaturation of glycoproteins followed by an enzymatic deglycosylation of the proteins and by the conversion into glycans of the residual glycosylamines in the solution which is obtained after deglycosylation of the proteins,
the derivatizion by permethylation as described in the abovementioned paper by Sophie Cholet et al. or better still by ethyl esterification of the sialic acids of the N-glycans of the solution which is obtained after deglycosylation, as described in the paper by Reiding et al., Anal. Chem., 86, 5784-5793 (2014), High-Throughput Profiling of Protein N-Glycosylation by MALDI-TOF-MS Employing Linkage-Specific Sialic Acid Esterification.

The process can comprise the addition of a polar solvent to the sample, in particular of an aqueous polar solvent of acetonitrile at 80%, prior to the passage of the sample through the porous monolith.

### Recyclability

The process can comprise the recycling of the porous material by heat treatment. The heat treatment can be carried out while keeping the porous monolith in the fluidic conduit. In an alternative way, the recycling heat treatment is carried out after the extraction of the porous monolith from the fluidic conduit. The heat treatment can be carried out by the heating of the porous monolith at a temperature of greater than or equal to 100° C., better still of greater than or equal to 150° C., even better still of greater than or equal to 200° C., for a period of time of greater than or equal to 0.5 h, even better still of greater than or equal to 1 h.

The process can comprise the reuse of the porous monolith after recycling.

### Encapsulation Process

According to another aspect, another subject matter of the invention is a process for the incorporation of a self-supporting porous monolith in a heat-shrinkable conduit, in particular made of polymer, comprising:
the incorporation of the porous monolith in the conduit,
the shrinkage of the conduit by heating the latter according to a predetermined temperature profile over time, the temperature profile over time being configured so that the porous monolith is held fixedly in the conduit and that the force applied to the self-supporting porous monolith is lower than the limiting force of resistance which a test porous monolith, manufactured by the same process as said self-supporting porous monolith, of the same length as said self-supporting porous monolith and with a greatest transverse dimension of less than or equal to 3 mm, would have.

The term “limiting force of resistance which a porous monolith would have” is understood to mean the force to not be exceeded in order not to damage the porous monolith.

Such an encapsulation process makes it possible to encapsulate all the sizes of porous monolith without damaging it, in particular the porous monoliths of less than 3 mm in diameter.

Preferably, the porous monolith exhibits a greatest dimension transverse to the conduit of less than or equal to 3 mm, better still of less than or equal to 2 mm, even better still of less than or equal to 1.5 mm.

The characteristics of the porous monolith, of the fluidic conduit and of the process for incorporation of the porous monolith which are described above apply independently of the extraction process.

Another subject matter of the invention is a process for solid-phase extraction of one or more compounds of interest from a liquid sample, comprising:
the incorporation of a self-supporting porous monolith in a fluidic conduit such as according to the aspect of the preceding invention,
at least one passage of the sample through the porous monolith in the fluidic conduit.

The characteristics described above in connection with the preceding extraction process apply independently of said extraction process.

### Glycomic Analysis Process

The invention also relates to a process for the glycomic analysis of a sample containing N-glycans, comprising:
at least one passage of the sample through a porous monolith preconditioned in order to adsorb the N-glycans of the sample, the porous monolith being incorporated in a conduit of a fluidic device,
the washing of the porous monolith by passage of a washing solution through the porous monolith,
the elution of the N-glycans by passage of an eluting solution through the porous monolith,
the withdrawal of the eluting solution at the outlet of the porous monolith,
the glycomic analysis of the withdrawn eluting solution.

The characteristics described above in connection with the preceding extraction process apply independently of said extraction process when they are compatible.

### BRIEF DESCRIPTION OF THE DRAWINGS

FIG. 1 diagrammatically represents an example of an extraction device which makes it possible to carry out the extraction process according to the invention,

FIG. 2 is a cut along II-II of the assembly of the conduit and of the porous monolith incorporated in the conduit of FIG. 1,

FIG. 3 is a view of a detail along III of FIG. 2,

FIG. 4 represents a process for the manufacture of a porous monolith making it possible to carry out the process according to the invention,

FIG. 5 represents different stages of a solid-phase extraction process according to the invention,

FIG. 6 represents the stage of recovery of the eluting solution at the outlet of the conduit after carrying out the extraction process,

FIG. 7 represents an alternative form of the solid-phase extraction process,

FIG. 8 represents an alternative form of the extraction device,

FIG. 9 represents an alternative form of the solid-phase extraction process,

FIG. 10 represents an alternative form of the extraction device,

FIG. 11 represents an alternative form of the extraction device,

FIG. 12 represents the spectrum of the N-glycans which are obtained from a human plasma resulting from an elution fraction at the outlet of the conduit after carrying out the process according to the invention for mass to charge ratios (m/z) of the identified molecules of between 1000 and 5000 Da,

FIG. 13 represents the spectrum of the N-glycans of FIG. 6 for m/z ratios of between 1100 and 2000 Da,

FIG. 14 represents the spectrum of the N-glycans of FIG. 6 for m/z ratios between 2000 and 3500 Da,

FIG. 15 represents the spectrum of the N-glycans of FIG. 6 for m/z ratios between 3400 and 4500 Da, and

FIG. 16 represents two spectra which are obtained for one and the same extraction process according to the invention on one and the same sample before and after recycling of the porous monolith.

### DETAILED DESCRIPTION

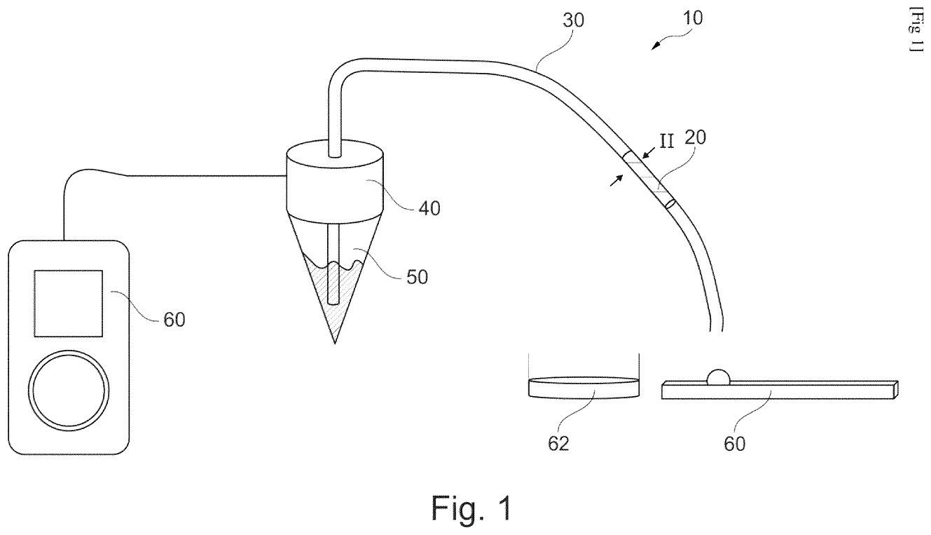

A device 10 for carrying out an extraction process according to the invention has been illustrated in FIG. 1. The device 10 comprises a porous monolith 20 incorporated in a fluidic conduit 30 so that any liquid traversing the fluidic conduit from side to side of the porous monolith 20 passes through the porous monolith 20, the latter acting as filter in the conduit 30.

The conduit is connected at one of its ends to a liquid feed member 40 for the conduit which can be connected removably to a liquid reservoir 50. The feed member 40 can also be connected to a pressure controller which makes it possible to control the pressure in the fluidic conduit and to control the fluidic movement in the latter. The other end of the conduit can be free. However, the invention is not limited to a free end. The latter might be connected to a member for distribution of the liquid of needle type. Such a free end makes it possible to deposit the moving solution at the outlet on an extraction support 60, in particular in a receptacle, an analysis well or a MALDI plate, in particular for the purpose of its analysis by an ancillary device, such as a MALDI-TOF, or in a receptacle 62, in particular a removal receptacle for recovering the various solutions to be removed during the process.

The porous monolith 20 and the conduit 30 are cylindrical in the embodiment illustrated. However, it might be otherwise. The invention is not limited to a particular shape even if the cylindrical shape is preferred.

The porous monolith 20 has a hierarchical porosity, exhibiting macropores and mesopores, and exhibits a diameter of less than or equal to 3 mm, in this instance substantially equal to 1 mm.

The various stages of an example of a process for the manufacture of the porous monolith are illustrated in FIG. 4.

The process comprises a first stage, not illustrated, of formation of an aqueous solution of a pore-forming agent and of a sol-gel precursor and of optional additives, in particular an acid and/or an agent for dissolution of the matrix.

The pore-forming agent can be chosen from water-soluble polymers, in particular polyethylene glycol (PEG), poly(acrylic acid), sodium poly(styrenesulfonate) acid and poly(ethyleneimine).

The water-soluble polymer(s) can exhibit a molecular weight of between 1000 and 100 000 daltons, preferably between 5000 and 50 000 daltons, even better still between 5000 and 30 000 daltons.

The concentration of pore-forming agent, in particular of PEG, can be between 0.015 g and 0.35 g per ml of sol, preferentially between 0.02 and 0.2 g per ml of sol. These values are linked to the concentration of sol-gel precursor, in particular of tetramethoxysilanes (TMOS), according to values of 0.03 to 1 g of pore-forming agent, in particular of PEG, per ml of sol-gel precursor, in particular of tetramethoxysilanes (TMOS), preferentially according to values of 0.06 to 0.6 g of pore-forming agent, in particular of PEG, per ml of sol-gel precursor, in particular of tetramethoxysilanes (TMOS). It is chosen as a function of the size of the macropores which is desired for the final porous monolith.

The sol-gel precursor can be chosen from alkoxides, in particular hydrolyzable and condensable organometallic compounds, in particular zirconium alkoxides, in particular zirconium butoxide (TBOZ), zirconium propoxide (TPOZ), titanium, niobium, vanadium, yttrium, cerium, aluminum or silicon alkoxides, in particular tetramethoxysilane (TMOS), tetraethoxysilane (TEOS), tetrapropoxysilane (TPOS), tetrabutoxysilane (TBOS), trimethoxysilanes, in particular methyltrimethoxysilane (MTMOS), propyltrimethoxysilane (PTMOS) and ethyltrimethoxysilane (ETMOS), triethoxysilanes, in particular methyltriethoxysilane (MTEOS), ethyltriethoxysilane (ETEOS), propyltriethoxysilane (PTEOS), aminopropyltriethoxysilane (APTES) and their mixtures, for example TMOS. It is also possible to use precursors, such as sodium silicates or titanium colloids, in particular if the purity requirements allow it, that is to say are not too high.

The proportion of pore-forming agent in the sol and the proportion of sol-gel precursor in the sol are predetermined as a function of the characteristics, in particular the total porosity and mean size of the macropores, of a selection of samples of known sol-gel matrices taken immediately after gelling.

The solution is subsequently stirred for a predetermined period of time of between 5 min and 3 h, even better still of between 15 min and 2 h, at a substantially constant controlled temperature of between 0° C. and 90° C., better still between 0° C. and 50° C. This stirring stage makes it possible to initiate the sol-gel process to form a sol 5 before the phase separation.

The sol 5 is then added in stage 2 to a receptacle 12 to fill, at least partially, said receptacle 12 and at least one mold 15 contained in the chamber 12.

The mold 15 can be positioned in the chamber which is gradually filled with the sol 5 so that the mold 15 is gradually filled without the presence of air bubbles or of chemical composition gradient. The filling can be carried out until the mold 15 is completely immersed. Partial immersion is also possible. The addition of the mold to the sol 5 contained in the chamber 12 is also possible.

The chamber 12 can be configured to contain a plurality of identical or different molds 15. The chamber 12 can be cylindrical, as illustrated, or have any other shape. The chamber 12 can be made of plastic, in particular of PTFE, PP, PE, PC, PET, PVC, or glass or stainless steel.

The mold(s) 15 comprise two openings 17 and 18 on opposite surfaces of the mold 15, one at least of the two openings 17 extending under the sol level after filling. Such openings make possible the filling of the mold(s) 15 by filling of the chamber 12 containing the mold(s) 15 or by at least partial immersion of the mold(s) 15 in the sol 5 contained in the chamber 12 and the movement of the sol 5 between the interior and the exterior of the mold(s) before the total condensation of the latter. In the example illustrated, the mold(s) 15 are in the form of tubes open at their two ends and extending vertically in the chamber 12 but the situation might be completely different; the tube might be oriented in the chamber differently and/or the mold might have another shape.

The mold(s) 15 can be entirely contained in the chamber 12, as illustrated, or can protrude from the latter. In the first case, the mold(s) 15 may or may not be completely immersed in the sol 5 after filling.

The mold(s) 15 can be made of plastic, in particular of PTFE, PEEK, FEP, PE, PP, or polylactic acid or of glass or of stainless steel, in particular of borosilicate or fused silica.

The mold(s) can be in a porous body.

The mold(s) can be formed by 3D printing or by molding.

The greatest transverse dimension of the cavity of the mold(s) 15, in particular the diameter d of this cavity, can be between 13 mm and 0.025 mm.

Once the sol 5 has been introduced into the chamber 12 and the mold(s) 15, condensation is carried out in stage 3 in the assembly of the chamber and of the mold. This sol-gel transition can be followed by an at least partial maturation (or aging) of the assembly. This stage makes it possible to ensure the formation of homogeneous macropores of a similar nature in the sol-gel matrix formed 22, whatever its shape and its size.

During the condensation, the temperature can be kept substantially constant, in particular between 15° C. and 90° C., preferentially 25° C. and 70° C., for a period of time of between 10 min and 4 h. The duration of the condensation and the predetermined temperature depend on the internal structure of the sol-gel matrix desired and on the duration of the agitation of the initial solution in the stage of formation of the sol.

The at least partial aging can last between 30 min and 2 weeks, in particular less than 72 h at ambient temperature. Preferably, the duration of aging is sufficiently short to prevent the formation of mesopores and/or micropores.

A block 22 of sol-gel matrix containing the mold 15 is then extracted from the chamber 12 at stage 4. In the case where the mold 15 is only partially immersed, this stage may be optional, as will be seen subsequently.

The mold 15 with the sol-gel matrix 25 which it contains is subsequently extracted from the porous solid at stage 5, for example by cutting the sol-gel matrix of the block 22 flush with the mold and by then withdrawing the mold 15 with the sol-gel matrix 25 which it contains, or else by breaking the sol-gel matrix of the block 22 around the mold 15. In the case where immersion was partial, it is possible to directly withdraw the mold 15 with the sol-gel matrix 25 which it contains from the previously extracted block or to directly withdraw from the chamber 12.

The sol-gel matrix 25 is then extracted from the mold 15 at stage 6. This is carried out by means of a controlled pressure exerted on the sol-gel matrix 25 while supporting the mold 15. The pressure can be obtained either with a solid made of plastic, of glass, such as a capillary tube made of fused silica for example, or any other material robust enough and with a smaller dimension than the mold 15, or with a gas at a controlled flow rate. The extraction operation can be facilitated by immersion of the mold 15 and sol-gel matrix 25 assembly in a liquid. It is optionally possible to generate a slight pressure difference by gently tapping the mold 15 and sol-gel matrix 25 assembly in order to extract the sol-gel matrix 25.

Once the sol-gel matrix 25 has been extracted from the mold 15, the process can comprise a stage of controlled generation of the mesoporosity. This stage can be carried out by immersion of the sol-gel matrix 25 or of the mold/sol-gel matrix assembly in a basic solution, for example a 1M ammonium hydroxide solution, or by heating the material in water in the presence of a precursor, for example urea, to generate ammonia in situ. It should be noted that, in the second method, it is possible to add more ammonium hydroxide. This operation can last between 0.5 h and 50 h at a substantially constant predetermined temperature of the sol-gel matrix of between 30° C. and 150° C. This stage can be carried out on several sol-gel matrices simultaneously, i.e. in one and the same bath, resulting from one and the same block or not.

Preferably, the size of the pores which is obtained is less than or equal to 50 nm, better still of between 2 and 50 nm.

The sol-gel matrix obtained is subsequently dried. To do this, it is placed in a closed container, in particular an autoclave, to be dried under critical or supercritical conditions, in particular under a stream of air or of inert gas, in particular molecular nitrogen (N₂), for a period of time of between 10 and 20 h. It is subsequently subjected to a gradient of 0.5° C./min up to 350° C. with a stationary phase of a few hours at this last temperature and under a stream of inert gas (other gases can be employed).

A ready-for-use self-supporting monolith is then obtained.

The porous monolith obtained preferably comprises macropores, i.e. exhibiting a chosen dimension of greater than or equal to 50 nm, and mesopores, i.e. exhibiting a chosen dimension of between 2 and 50 nm.

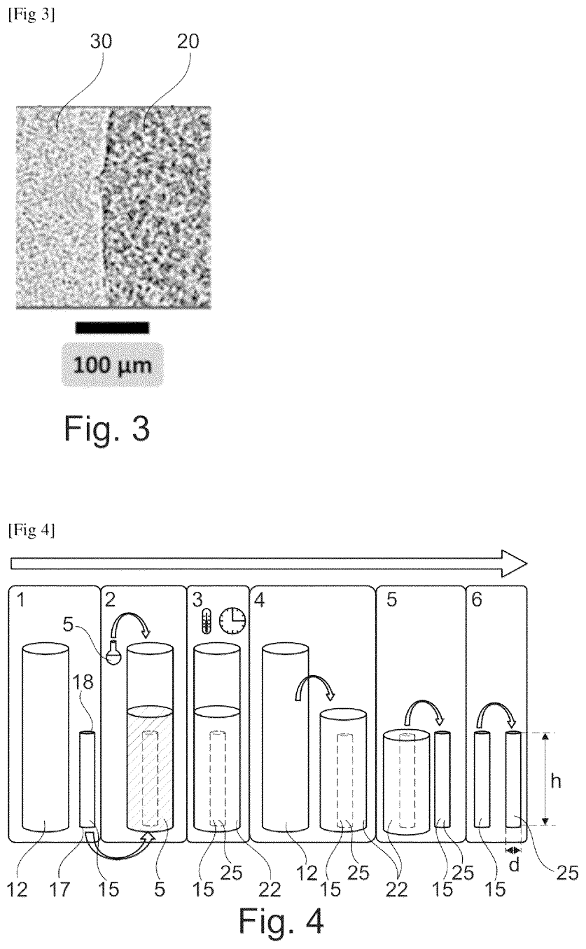

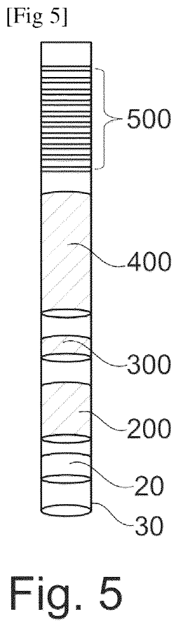

It is preferentially of substantially homogeneous structure throughout its volume, as can be seen in FIG. 3.

The porous monolith(s) can exhibit an aspect ratio, defined as its height to its greatest transverse dimension, of between 0.2 and 100.

The process can comprise modifications to the porous monolith after manufacture, in particular the functionalization of the internal surfaces of the porous monolith. The functionalization can be carried out according to liquid-phase or else gas-phase processes, using organosilanes, in particular chlorosilanes (e.g. octadecyltrichlorosilane), and alkoxysilanes (octadecyltriethoxysilane, aminopropyltriethoxysilane, propyltrimethoxysilane), or alternatively also hexadimethylsilazane.

In an alternative form, the mold(s) may have only one opening. The latter opens into the sol after filling in order to make possible the movement of the sol between the mold and the chamber.

In an alternative form, the initial solution can be an emulsion or a templating solution containing sol-gel precursors.

The porous monolith 20 obtained by this treatment is self-supporting and can be incorporated in the heat-shrinkable conduit 30.

The fluidic conduit is semi-rigid and heat-shrinkable. It exhibits, before shrinkage, an internal diameter which is greater than the external diameter of the porous monolith and, after shrinkage, an internal diameter which is smaller than the external diameter of the porous monolith. Preferably, the minimum diameter of the conduit is strictly smaller than the diameter of the porous monolith. It can be between 95% and 85% of the diameter of the porous monolith.

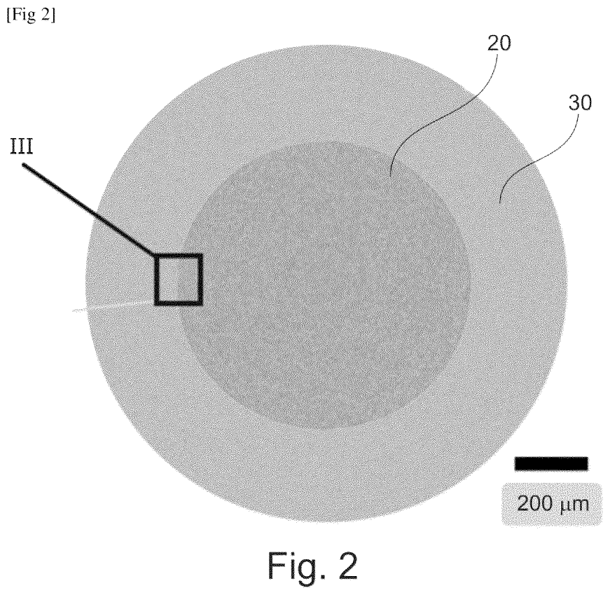

The porous monolith is incorporated in the conduit by insertion into the conduit before shrinkage and then heating of the conduit to a temperature which is a function of the heat-shrinkable material, in particular of greater than or equal to 70° C., so that the conduit shrinks over the porous monolith without damaging it until its diameter has narrowed such that the porous monolith is fixedly encapsulated and that any liquid solution which traverses the conduit passes through the porous monolith, that is to say without space between the inner wall of the conduit and the outer wall of the porous monolith, as can be seen in FIGS. 2 and 3.

It is also possible to incorporate several porous monoliths in parallel in order to treat several samples or several fractions of a sample.

A description will now be given of a process for solid-phase extraction (SPE) of compounds of interest from a sample.

The process comprises the passage through the porous monolith of various successive solutions making possible the extraction of the compounds of interest. All the successive solutions can be inserted beforehand at the conduit head, that is to say upstream of the porous monolith.

The extraction process can first comprise a stage of conditioning by passage of a conditioning solution 200 through the porous monolith 20. It makes it possible to prepare the porous monolith for the adsorption of the compounds of interest by impregnating it with a solution having a polarity close to that of the sample. The conditioning solution 200 can be an aqueous acetonitrile solution, for example containing 80% by weight of acetonitrile. The conditioning solution is removed at the outlet.

The sample 300 is then passed through the porous monolith 20. During its passage, the compounds of interest present in the latter adsorb at the surfaces of the porous monolith due to their greater affinity for the surfaces than for the solvent of the sample. The sample 300 can be passed a single time through the porous monolith. In an alternative form, it is possible to make it pass several times by making it go back and forth through the porous monolith 20. The liquid of the sample remaining at the outlet can be removed.

The porous monolith 20 is subsequently washed with a washing solution 400 for which the compounds of interest exhibit a lower affinity than for the walls of the porous monolith 20. The washing solution 400 can be an aqueous solution of acetonitrile at 95% by weight. The washing solution 400 is removed at the outlet of the porous monolith.

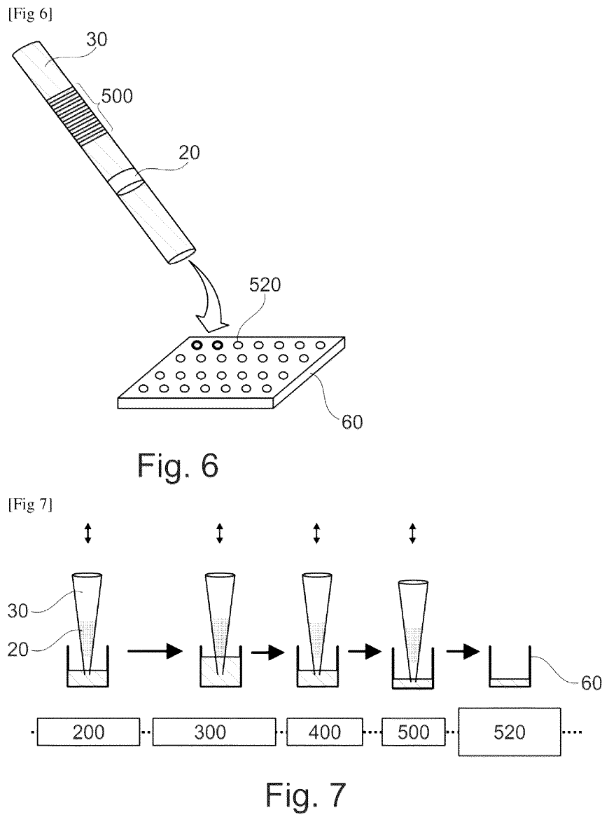

Finally, as illustrated in FIG. 6, a succession of successive fractions of eluting solution 500 are entrained through the porous monolith. Each fraction of eluting solution is recovered at the outlet of the porous monolith on different spots or in different wells 520 of an analytical plate. The eluting solution is a solution for which the compounds of interest have more affinities, in particular pure water, so that the compounds of interest are entrained in the fractions of eluting solution. The various fractions of eluting solution are recovered at the outlet in order to be analyzed. The analysis of the compositions of the various fractions of eluting solution makes it possible to deduce therefrom the proportions of the compounds of interest in the initial sample. The analysis is carried out, for example, by MALDI-TOF, LC-FLUO or CE-LIF, in particular in the case of N-glycans.

In an alternative form illustrated in FIG. 7, the porous monolith 20 is encapsulated in a heat-shrinkable conduit 30 of noncylindrical shape, in particular of conical shape.

The passage of the various solutions, in particular the conditioning solution 200, the sample 300, the washing solution 400 and the eluting solution 500, can be carried out through the porous monolith by one or more suction and then reversing stages, as illustrated by the double arrow at each stage of FIG. 7. The various solutions thus pass at least twice through the porous monolith 20 in one direction and then in the other. After passage through the porous monolith, the solutions to be removed are recovered in removal receptacles 62 and the solutions to be analyzed are recovered in an analysis receptacle or well or are deposited directly on a MALDI analytical plate 60.

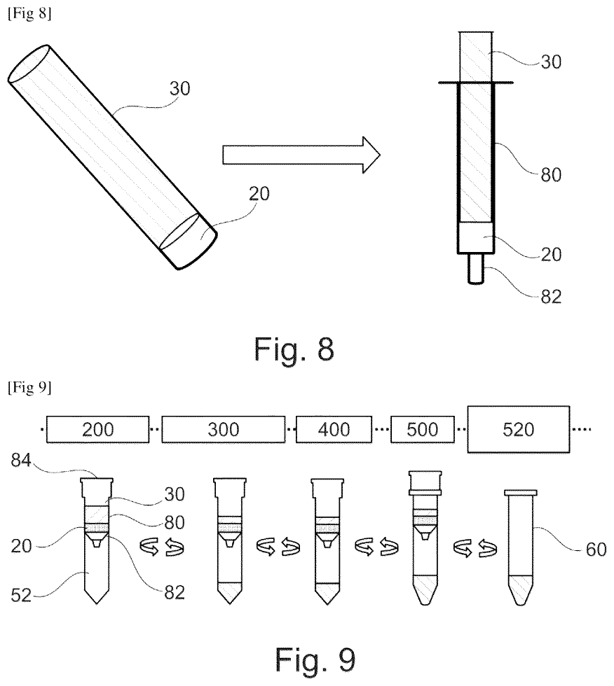

In an alternative form illustrated in FIG. 8, the fluidic conduit 30 after encapsulation of the porous monolith is inserted into a solid-phase extraction cartridge 80, in particular of syringe body type. The various solutions are then recovered after passage through the porous monolith via the outlet nozzle 82 of the extraction cartridge 80. Such an extraction cartridge can be used as described above or as described below.

In an alternative form illustrated in FIG. 9, the passage of the solutions 200, 300, 400 and 500 through the porous monolith 20 can be driven by centrifugation. The porous monolith 20 can be incorporated in an extraction cartridge, the upper end of which can be closed by a stopper 84. The conditioning solution 200 is added to the extraction cartridge 80 upstream of the porous monolith 20 and the cartridge 80 is closed by means of the stopper 84. The cartridge is arranged above a removal receptacle 62. The assembly formed of the receptacle 62 and of the cartridge 80 is centrifuged so as to cause the conditioning solution to pass through the porous monolith 20 and to recover it in the receptacle 62. The sample 300 and the washing solution are passed through the porous monolith 20 and recovered in the same receptacle or another receptacle 62 in the same way. The cartridge is subsequently inserted into an extraction receptacle 60 in order to recover the eluate by passage of the eluting solution 500 through the porous monolith in the same way.

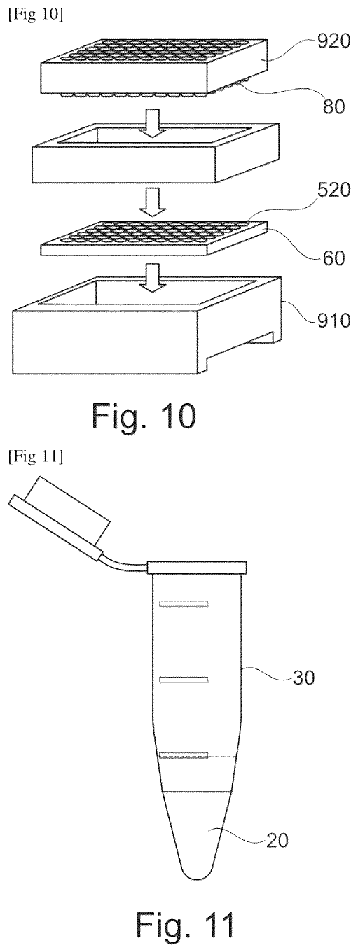

In an alternative form illustrated in FIG. 10, all the stages of the process can be carried out using a multiwell system 900 comprising a vacuum base 910, receiving a receptacle or a multiwell plate 60, on which an extraction plate 920 is mounted. The extraction plate 920 comprises a matrix of extraction cartridges 80 in which the porous monoliths are incorporated. This plate 920 is placed, depending on the stage of the process, on a removal receptacle 62, not illustrated, in order to recover the solutions to be removed, or on a multiwell plate 60 exhibiting an extraction well 520 per extraction cartridge, in order to recover the eluate at the outlet of each cartridge. The passage of the various solutions through the porous monolith can be driven by means of an air suction pump in the vacuum base 910. Such a system makes it possible to carry out several extractions simultaneously.

In the alternative form illustrated in FIG. 11, the extraction can be carried out by solid-phase extraction. In this case, the porous monolith can be incorporated in a fluidic conduit closed at its end, in this instance a receptacle, in particular of the Eppendorf® tube type. The porous monolith can extend to the bottom of the receptacle and be fixed to the bottom of the receptacle. The various solutions are then added to the receptacle containing the porous monolith. The tube is agitated to accelerate the exchanges between the solutions and the porous monolith. The solutions are then extracted from the receptacle, in particular by inverting the latter or by pipetting.

### EXAMPLE 1

The N-glycomic analysis of a human plasma sample is described in detail below.

A self-supporting monolith with a diameter of approximately 800 μm, having macropores of approximately 2 μm and mesopores of approximately 15 nm which are generated by immersion in a basic solution, is manufactured.

A solution is prepared by mixing 0.33 g of PEG with 2 ml of TMOS in 4 ml of 0.01 M acetic acid. The solution is stirred at 0° C. for 30 min to form a sol and then transferred into a polypropylene (PP) receptacle in which a PTFE tube with a diameter of approximately 1 mm was positioned vertically beforehand. Filling is carried out by gradually adding the sol to the chamber by means of a micropipette starting from the lowest point. The amount of solution added is such that the mold is completely immersed.

The chamber is placed at a temperature of 40° C. and gelling occurs between 45 and 50 min after the transfer into the chamber. After gelling has taken place, the gel is left to age at 40° C. for 24 h. Then the sol-gel matrix resulting from the gelling and the maturation is extracted from the chamber and broken with a metal clamp in order to recover the mold which has been incorporated therein. The monolithic sol-gel matrix encapsulated in the mold is subsequently extracted by means of manual pressure exerted by a tube with a diameter of less than 1 mm. For this protocol, this pressure by a solid tube is sufficient to carry out the extraction of the monolith and does not weaken the gel.

The sol-gel matrix obtained is rapidly immersed in a 1M NH₄OH solution, while observing a ratio of approximately 5 between the volumes of basic solution and the volume occupied by the sol-gel matrix.

The matrix obtained is subsequently placed in an autoclave. The latter is placed in an oven and connected by tubes which make possible circulation of gas. The gel is then dried under N₂ for 12 h. Finally, a heat treatment is carried out with a gradient of 0.5° C./min up to 350° C. and a stationary phase at the latter temperature of 2 h.

The monolith with a diameter of 0.8 mm is placed in a heat-shrinkable PTFE tube with an internal diameter before shrinkage of 1.27 mm. The tube has a length of at least 10 cm.

The assembly is then subjected to a localized increase in temperature at the place where the monolith is positioned, by means of a heating gun regulated at a temperature of 500° C. The heat is manually distributed over the tube by a steady movement of the nozzle of the gun and shrinkage occurs while doing this to encapsulate the monolith. The shrinkage of the tube is monitored visually. The diameter of the PTFE after shrinkage is less than 0.7 mm. This stage can also be carried out in an oven at a temperature of 350° C. for at least 10 min.

The tube containing the encapsulated porous monolith is ready for use. It is then connected to a pressure controller via a reservoir connector in which four containers can be placed, one for each solution (conditioning/sample/washing/eluting).

At the outlet of the device, the fluids introduced are recovered in a trash container (the first three stages) and the eluates (final stage) are, for their part, deposited directly on a MALDI plate.

34 μl of dilute plasma (containing 5 μl of withdrawn plasma) are added to a sodium phosphate buffer, 100 mM, pH 7.4, (10 μl) and to 10 mM dithiothreitol (5 μl) before denaturing the plasma glycoproteins by heating at 95° C. for 5 minutes. After cooling to ambient temperature, 2 μl of a solution of PNGase F (1 U/μl) are added and the deglycosylation of the proteins is carried out overnight (about 16 hours) at 37° C. The residual glycosylamines are converted into glycans by incubation with 5 μl of 1 mol/l hydrochloric acid at 37° C. for 45 minutes.

A 0.25 M EDC/0.25 M HOBt mixture is prepared in ethanol as activating agent for carrying out ethyl esterification reactions, which induce the esterification of the α2,3-linked sialic acids and the lactonization of the α2,6-linked sialic acids.

The derivatization is carried out by adding 3 μl of sample of N-glycans which have been released beforehand (equivalent respectively to 0.3 μl of human plasma) to 20 μl of esterification reagent respectively, followed by incubation with stirring at 350 rpm at 37° C. for 1 h 30. After that, 50 μl of 80% ACN are added to form the extraction sample, 10 minutes before proceeding to the extraction of the N-glycans with the silica monolith and to the MALDI-TOF-MS analysis.

For each stage, the solutions are charged into a container and sent by positive pressure by means of a pressure controller into the PTFE tube containing the material. It is also possible to proceed in negative pressure with the pressure controller. The positive and negative pressures can also be applied with syringe drivers, indeed even manually. It is also possible with this device to proceed to suction-reversing cycles to carry out the purification.

The monolith encapsulated in PTFE is conditioned and equilibrated with 3×1 ml of pure water, followed by 3×1 ml of 80% aqueous ACN. Subsequently, the 73 μl of the extraction sample are charged and then washed with 20 μl of 95% ACN. Finally, the N-glycans are eluted as 10 successive fractions of 1 μl of pure water. Each fraction is deposited directly on the MALDI plate by means of the device. It should be noted that, in the protocol, no trifluoroacetic acid is used.

1 μl of the solution of 2,5-DHB matrix (2,5-dihydroxybenzoic acid, 10 mg/ml in 50% methanol) is added and mixed with each of the 1 μl fractions deposited during the direct elution on the plate. After a first crystallization, 0.2 μl of ethanol are deposited in order to recrystallize and to improve the reproducibility results during the analyses.

Finally, each spot on the MALDI plate is analyzed with a MALDI-TOF/TOF instrument, in particular the UltrafleXtreme from Bruker equipped with a laser, in particular the Smartbeam-II from Bruker. As regards the acquisition conditions, the mass spectrometry spectra were acquired at a repetition frequency of the laser of 2 kHz in positive mode, with an acceleration voltage of 20 kV and an extraction time delay of 130 ns. The spectra are obtained by accumulating 5000 shots on windows with masses of 1100 to 5000 Da for the plasma N-glycans and of 500 to 5000 Da for samples of free oligosaccharides from breast milk (HMOs, see example 2).

After carrying out the purification protocol for human plasma, profiles of N-glycans on fractions 2 to 4 were obtained by mass spectrometry with an optimal spectrum obtained for the third fraction.

A calibration was carried out and the peaks were identified by the software of the mass spectrometry device.

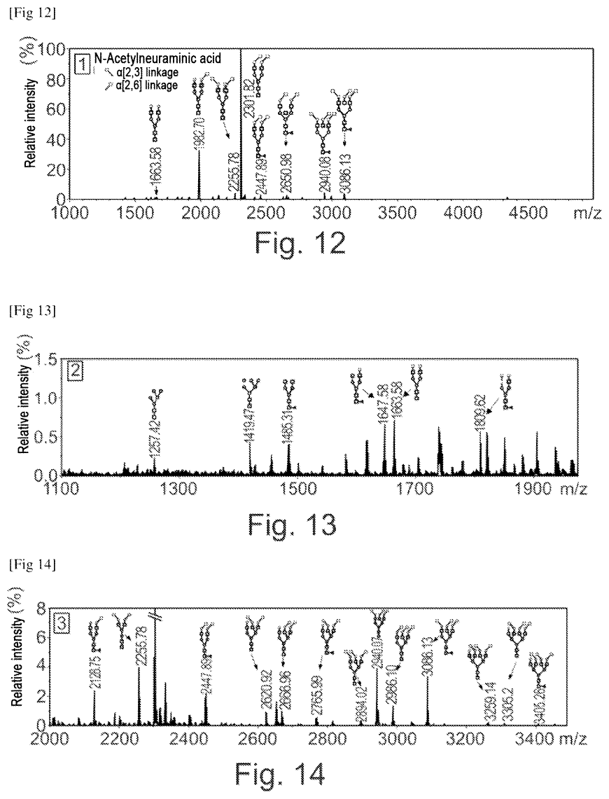

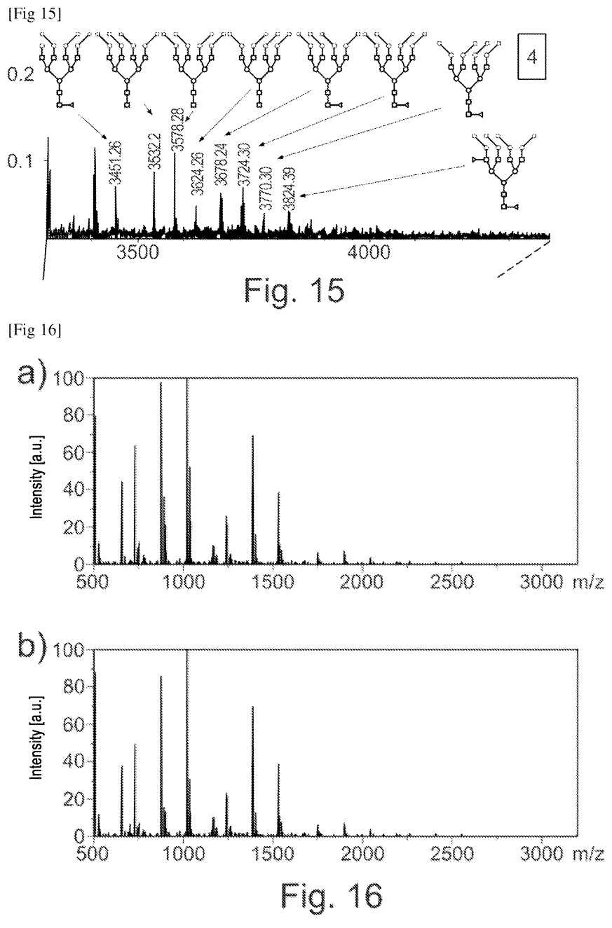

The spectrum obtained is illustrated in FIGS. 12 to 15. The analysis made it possible to differentiate more than 58 plasma N-glycans of different compositions, some of which are illustrated, which correspond to more than 81 kinds of N-glycans due to the variation in the bonding of the sialic acid. The 8 predominant structures were found, namely H5N4E2 (m/z 2301), H5N4E1 (m/z 1982), H5N4E1L1 (m/z 2255), H6N5E2L1 (m/z 2940), H5N4F1E1 (m/z 2128), H5N4F1E2 (m/z 2447), H6N5F1E2L1 (m/z 3086) or H6N5E2L1 (m/z 2986). The proportions of the mono-and bisialylated biantennary glycans, H5N4E1 (m/z 1982) and H5N4E2 (m/z 2301), which are the two predominant structures usually found, exhibit proportions of 1:3.

### EXAMPLE 2

A cylindrical self-supporting porous monolith with a diameter of 5 mm and a length of 9 mm was manufactured by the same process as that described in example 1. It was incorporated in a heat-shrinkable PTFE tube with a length of greater than 9 mm by the incorporation process of example 1 and then placed in a cartridge of SPE type, as illustrated in FIG. 8.

The SPE cartridge containing the encapsulated porous monolith is ready to be employed for an extraction. The SPE cartridge is placed under vacuum at −0.2 bar.

50 μl of human milk were diluted, vortexed and subsequently centrifuged at 15 KG at 2° C. for 30 minutes. After that, the supernatants were removed and 200 μl of acetonitrile (ACN) were added to the samples before being subjected to vortexing.

The SPE cartridge containing the monoliths is conditioned and equilibrated successively three times with 1 ml of water, then three times with 1 ml of 80% ACN. Subsequently, the samples were charged and washed 12 times with 200 μl of 95% ACN. Finally, the elution of the free oligosaccharides of milk (HMOs) is carried out with 200 μl of H₂O in a 2 ml tube before being dried under a stream of nitrogen and being analyzed by mass spectrometry. The spectrum obtained is illustrated in FIG. 16, spectrum a.

After this first extraction, the cartridge is withdrawn. The porous monolith and the PTFE are heat treated under a stream of nitrogen at an initial temperature of 40° C., followed by a gradient of 210 minutes up to a final temperature of 250° C. for two hours. Subsequently, the treated part is recovered and placed back in the cartridge and then the previous extraction protocol is again employed. The conditioning and eluting fractions were recovered and analyzed by mass spectrometry.

In the conditioning fractions of this second extraction, no oligosaccharide or other residual compounds were detected, testifying to the satisfactory regeneration of the porous monolith. As regards the eluting fractions, profiles of free oligosaccharides were obtained. An example of mass spectrum obtained is illustrated in FIG. 16, spectrum b.

It can be observed that the spectra of FIG. 16 which are obtained respectively by the first and the second extraction are similar, which clearly indicates that the porous monolith can be used several times.

The invention is not limited to the examples which have just been described.

For example, the porous monolith has a shape other than those described. The fluidic device can be other than as described; in particular, the pressure can be controlled in another way.

1. A process for solid-phase extraction of one or more compounds of interest from a liquid sample, comprising:
the incorporation of a self-supporting porous monolith in a fluidic conduit so that the self-supporting porous monolith is fixed in the fluidic conduit during said process and forms a filter in the fluidic conduit,
at least one passage of the through the porous monolith in the fluidic conduit over at least a portion of the porous monolith,
the self-supporting porous monolith having a greatest dimension transverse to the fluidic conduit of less than or equal to 3 mm,
the fluidic conduit exhibiting one or more open ends before incorporation, the or at least one of the ends remaining open during the stage of incorporation of the porous monolith.

2. The process as claimed in claim 1, the self-supporting porous monolith being formed by a manufacturing process comprising:
the formation of a sol comprising a sol-gel precursor in aqueous solution and, preferably, and a pore-forming agent,
the at least partial filling of a chamber and of at least one mold contained in the chamber with sol formed previously, the mold comprising at least one opening which opens into the sol after filling with sol,
the formation of a sol-gel matrix in the chamber starting from the sol,
the extraction of the mold with the sol-gel matrix contained in the mold from the chamber, and
the extraction of the sol-gel matrix from the mold,
the formation of a porous monolith starting from the sol-gel matrix extracted from the mold,
the formation of the sol, of the sol-gel matrix and of the porous monolith taking place by a sol-gel process.

3. The process as claimed in claim 1, the porous monolith having a hierarchical porosity.

4. The process as claimed in claim 1, in which the porous monolith exhibits a greatest dimension transverse to the conduit of less than or equal to 2 mm.

5. The process as claimed in claim 1, comprising modifications to the porous monolith after manufacture.

6. The process as claimed in claim 1, in which the fluidic conduit is made of a heat-shrinkable polymer, and the incorporation of the porous monolith in the fluidic conduit comprises the insertion of the porous monolith into the fluidic conduit and the heating of the fluidic conduit in order to shrink the conduit so as to encapsulate the porous monolith in the conduit.

7. The process as claimed in claim 1, in which the porous monolith retains its integrity during the stage of incorporation in the fluidic conduit.

8. The process as claimed in claim 1, in which the heating of the conduit is carried out at a temperature which is greater than or equal to the minimum shrinkage temperature of the conduit and which is less than or equal to the melting or degradation temperature of the fluidic conduit.

9. The process as claimed in claim 1, in which the fluidic conduit exhibits, at its or one of its open ends, after incorporation of the porous monolith, a non-zero length of conduit devoid of porous monolith.

10. The process as claimed in claim 1, the process being a process of solid-phase extraction of compounds of interest by adsorption of the latter on the surfaces of porous monoliths in order to separate them from the remainder of the sample, then recovery by elution of the compounds of interest adsorbed on the surfaces of the porous monolith.

11. The process as claimed in claim 1, comprising, before the passage of the sample, the conditioning of the porous monolith by passage of one or more successive conditioning solutions in the fluidic conduit through the porous monolith and/or, after the passage of the sample in the fluidic conduit, the washing of the porous monolith by passage of one or more washing solutions in the fluidic conduit through the porous monolith.

12. The process as claimed in claim 1, comprising, after the passage of the sample and after the washing, the elution of the compounds of interest by passage of an eluting solution or of several fractions of eluting solution through the porous monolith in the fluidic conduit and the recovery of the eluting solution or of each fraction of eluting solution after its passage through the porous monolith for the purpose of its analysis in order to determine the composition thereof of compounds of interest.

13. The process as claimed in claim 12, comprising the analysis by mass spectrometry, by liquid chromatography coupled to detection by fluorescence (LC-Fluo) or by capillary electrophoresis coupled to fluorescence (CE-LIF), after recovery of the eluting solution without a prior stage of drying or of concentration of the eluting solution.

14. The process as claimed in claim 1, comprising the recycling of the porous material by heat treatment.

15. The process as claimed in claim 1, in which the sample which passes through the porous monolith comprises free N-glycans or oligosaccharides and the porous monolith is configured to adsorb these entities contained in the sample during the passage of the latter through the porous monolith, the process additionally comprising:
the washing of the porous monolith by passage of a washing solution through the porous monolith,
the elution of the N-glycans by passage of an eluting solution through the porous monolith,
the withdrawal of the eluting solution at the outlet of the porous monolith,
the glycomic analysis of the withdrawn eluting solution.
